(19) United States
(12) Patent Application Publication
(10) Pub. No.: US 2012/0312422 A1
(43) Pub. Date: Dec. 13, 2012

(54) METHOD OF PRODUCING NANOCOMPOSITE MAGNET

(75) Inventors: Masao Yano, Susono-shi (JP); Noritsugu Sakuma, Susono-shi (JP); Tetsuya Shoji, Susono-shi (JP)

(73) Assignee: TOYOTA JIDOSHA KABUSHIKI KAISHA, Toyota-shi, Aichi-ken (JP)

(21) Appl. No.: 13/522,550

(22) PCT Filed: Jan. 27, 2011
(86) PCT No.: PCT/IB2011/000139

§ 371 Date: Jul. 17, 2012

(30) Foreign Application Priority Data
Jan. 29, 2010 (JP) 2010-019074

(51) Int. Cl. H01F 41/02; C22F 1/00

(52) U.S. Cl. 148/121

(57) ABSTRACT

A molten alloy that has a nanocomposite magnet composition is quenched and solidified to fabricate a foil that has a polycrystalline phase composed of a hard magnetic phase with an average crystal grain diameter of 10 to 200 nm and a soft magnetic phase with an average crystal grain diameter of 1 to 100 nm. The foil that includes a low melting point phase that is formed on a surface of the foil and that has a melting point that is lower than that of the polycrystalline phase is sintered.

### BACKGROUND OF THE INVENTION

1. Field of the Invention

The present invention relates to a method of producing a nanocomposite magnet in which a nano-sized hard magnetic phase and a nano-sized soft magnetic phase are compounded with each other.

2. Description of the Related Art

A nanocomposite magnet includes a two-phase composite structure that is composed of a hard magnetic phase and a soft magnetic phase. Because the hard magnetic phase and the soft magnetic phase are nano-sized, exchange coupling occurs between the hard and soft magnetic phases, which significantly increases residual magnetization and saturation magnetization. In the present invention, the term “nano-sized” refers to a minute size of about 200 nm or less.

A bulk body that has such a nano-sized structure may be produced by quenching a molten material having a nanocomposite composition to obtain powder or a foil, and sintering the powder or the foil.

Japanese Patent Application Publication No. 09-139306 describes a method of crushing a quenched foil into powder and sintering the powder. The quenched foil is fabricated by a single roll method. An amorphous phase may be generated during quenching, and thus a heat treatment is performed for crystallization. In order to also perform the crystallization heat treatment, and to obtain a sufficiently high sintered density, the powder is sintered by hot pressing at temperatures as high as 800° C.

In the above method, however, crystal grains growth may be occurred by the crystallization heat treatment or the high-temperature sintering, which may reduce the coercive force.

Japanese Patent No. 2693601 describes a method of fabricating the quenched foil by a twin roll method. However, no consideration is made to prevent generation of an amorphous phase, and thus the above problem cannot be avoided.

### SUMMARY OF INVENTION

The present invention provides a method of producing a nanocomposite magnet composed of fine crystal grains that has high magnetization and a high coercive force without requiring crystallization heat treatment or high-temperature sintering.

An aspect of the present invention is directed to a production method for a nanocomposite magnet. The production method for a nanocomposite magnet includes: quenching and solidifying a molten alloy that has a nanocomposite magnet composition to fabricate a foil that has a polycrystalline phase composed of a hard magnetic phase with an average crystal grain diameter of 10 to 200 nm and a soft magnetic phase with an average crystal grain diameter of 1 to 100 nm; and sintering the foil that includes a low melting point phase that is formed on a surface of the foil and that has a melting point that is lower than that of the polycrystalline phase to obtain the nanocomposite magnet.

Thus, sintering progresses at a temperature that is lower than the melting point of the polycrystalline phase, which prevents grain growth of the polycrystalline phase so that the nano-sized crystal grains formed during the solidification can be maintained.

### BRIEF DESCRIPTION OF DRAWINGS

The foregoing and further features and advantages of the invention will become apparent from the following description of example embodiments with reference to the accompanying drawings, wherein like numerals are used to represent like elements and wherein:

FIG. 1 is a schematic diagram that shows a method of fabricating a quenched foil using a single roll method in accordance with an embodiment of the present invention;

FIG. 2 is a schematic diagram that shows the principle of dividing quenched foils between amorphous quenched foils and crystalline quenched foils using a weak magnet;

FIG. 3 is a graph that shows the magnetic characteristics of a nanocomposite magnet, which is made of crystalline material, fabricated in accordance with the present invention in comparison to quenched foils (before being sintered) and a nanocomposite magnet, which is made of amorphous material, according to a comparative example;

FIG. 4A is a reflection electron image that shows the structure of the nanocomposite magnet according to the present invention, and FIG. 4B is a reflection electron image that shows the structure of the nanocomposite magnet according to the comparative example; and

FIG. 5 is a schematic diagram that qualitatively shows the relationship between the quenching rate and the generation of a low melting point phase.

### DETAILED DESCRIPTION OF EMBODIMENTS

A nanocomposite magnet composition used in the method according to present invention is typically represented by the following formula. However, the formula is not necessarily limiting.

Composition formula: RₓQ_{y}M_{z}T_{1-x-y-z}, where:

R is at least one of the rare-earth elements;

Q is at least one of B and C;

M is at least one element selected from Ti, Al, Si, V, Mn, Cu, Zn, Ga, Zr, Nb, Mo, Ag, Hf, Ta, W, Pt, Au, or Pb;

T is Fe or Fe alloy that includes at least one of Co and Ni;

2≦x≦11.8;

1≦y≦24; and

0≦z≦10.

A hard magnetic phase, which serves as a main phase, is R₂T₁₄M, and a soft magnetic phase is a compound of αFe or Fe and B or C.

A polycrystalline foil according to the present invention is composed of a nanocrystalline phase in which a hard magnetic phase and a soft magnetic phase are compounded. The hard magnetic phase (as the main phase) has a crystal grain diameter of 10 nm to 200 nm and the soft magnetic phase has a crystal grain diameter of 1 nm to 100 nm. In the present invention, a low melting point phase is provided on one surface of the polycrystalline foil. The melting point of the low melting point phase is lower than that of the polycrystalline phase that forms the foil.

The nanocomposite magnet according to the present invention, is formed by sintering a quenched crystalline phase foil. A low melting point phase is provided on one surface of the foil. The melting point of the low melting point phase is lower than that of the crystalline phase of the main body of the foil. This permits low-temperature sintering, which makes it possible to preserve the nano-sized crystal grains which are obtained through solidification and to obtain high magnetic properties while avoiding growth of the crystal grains that may occur during sintering.

The low melting point phase preferably has a thickness of 500 nm or less, and has a volume fraction of 3% or less of the main body of the polycrystalline foil. If the proportion of the low melting point phase is too high, the magnetic characteristics may be adversely affected.

To form the low melting point phase, quenching is typically performed by a single roll method. That is, quenching (solidification) is performed only in one direction to make a solidified texture crystalline so that a remaining liquid phase portion (a finally solidified portion, that is, the low melting point phase) is formed on one surface of the foil. If the solidified texture is amorphous, the low melting point phase is not likely to appear on a surface of the foil as the remaining liquid phase portion.

In addition to solidification via a single roll method, the low melting point phase may also be formed through other processes, such as by applying a low melting point phase to one surface of the solidified foil by electrolytic precipitation, sputtering, or chemical reduction.

The low melting point phase needs to have a melting point that is lower than that of the main phase (hard magnetic phase), such as Nd₂Fe₁₄B, (which has a melting point of 1155° C.), for example. The soft magnetic phase is typically Fe, which has a melting point of 1535° C., which is higher than that of the main phase. The low melting point phase may be formed from a simple metal, an alloy, an intermetallic compound, in particular, a eutectic compound, or the like. In particular, the low melting point phase may be, for example, Al, Ag, Bi, Ce, Ga, Ge, In, La, Li, Mg, Rb, Sb, Se, Sn, Sr, Te, Tl, Nd, Cu, Zn, Nd₃Ga (which has a melting point of 786° C.), DyCu (which has a melting point of 790° C.), NdCu (which has a melting point of 650° C.), Nd₃Al (which has a melting point of 675° C.), Nd₃Ni (which has a melting point of 690° C.), AlNd₃ (which has a melting point of 675° C.), or Fe₇₅Nd₂₅ (which has a melting point of 640° C.).

In the present invention, the low melting point phase is provided on one surface of the quenched foil, to facilitate low temperature sintering. The sintering temperature is preferably typically 500 to 650° C., and more preferably 500 to 600° C., which is a temperature range that can avoid the growth of the crystal grains.

The crystalline quenched foil may be sintered at a pressure of 200 MPa or more.

In order to prevent the growth of the crystal grains, the rate of temperature increase during the sintering process is preferably as high as possible. The temperature increase rate during the sintering may be set to, for example, 20° C./min or more.

By sintering the crystalline quenched foil that includes a low melting point phase, a nanocomposite magnet sintered body with excellent magnetic characteristics equivalent to those of the crystalline quenched foil before sintering may be obtained. The sintered body has a density of at least 90% of the theoretical density, and also has excellent mechanical properties and durability.

A nanocomposite magnet having the following composition was produced in accordance with the present invention.

Main phase (hard magnetic phase): Nd₂Fe₁₄B

Soft magnetic phase: αFe

Main phase: soft magnetic phase=9:1

The respective amounts of Nd, Fe, and FeB required in the above composition were weighed out and melted in an arc melting furnace to form an alloy ingot.

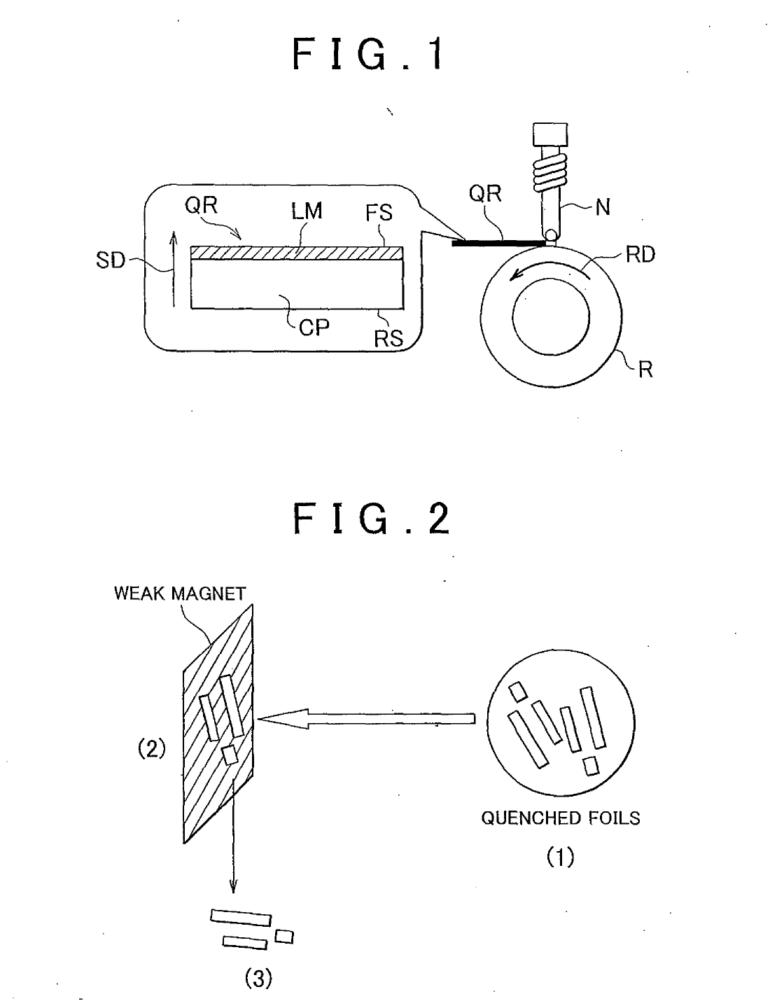

The alloy ingot is then melted via high-frequency induction melting. In a furnace under a reduced-pressure Ar atmosphere of 50 kPa or less, a quenched foil is fabricated using a single-roll melt spinning method as shown in FIG. 1, in which the molten alloy is injected onto a copper roll. The processing conditions are shown in Table 1.

TABLE 1
Use conditions of quenching device

| | | |
|---|---|---|
| Nozzle diameter | 0.6 | mm |
| Clearance | 0.7 | mm |
| Injection pressure | 0.4 | kgf/cm³ |
| Roll feed rate | 2350 | rpm |
| Melting temperature | 1600° | C. |

The method of fabricating the quenched foil that includes the low melting point phase according to the present invention will be described with reference to FIG. 1. In the balloon in the drawing, an enlarged partial cross-sectional view of the quenched foil is shown.

In the single roll method shown in FIG. 1, when the molten alloy is discharged from a feed nozzle N onto the outer peripheral surface of a single roll R, the molten metal is quenched and solidified from one side by the roll R so that a quenched foil QR comes out of the outer peripheral surface of the single roll R in the rotational direction RD of the roll. As shown in the balloon as enlarged, the direction of cooling (cooling direction SD) of the roll R extends from the roll contact surface RS that contacts the roll R toward the free surface FS that does not contact the roll R so that the solidification progresses in the direction SD. Therefore, the molten metal is finally solidified on the free surface FS, on which a composition with the lowest melting point in the cross section is formed. That is, segregation occurs along the thickness direction of the quenched foil QR during such a quenching process to form a low melting point phase LM on one surface of a polycrystalline phase CP. In this way, by performing single-roll rapid solidification, a low melting point phase is formed on one surface of the quenched foil serving as a raw material to be sintered, which allows low-temperature sintering.

As shown in FIG. 2, the quenched foils are sorted between crystalline quenched foils and amorphous quenched foils using a weak magnet. That is, among the quenched foils (1), the amorphous quenched foils are magnetized by the weak magnet and thus do not fall down (2), and the crystalline quenched foils are not magnetized by the weak magnet and thus fall down (3).

After separation, only the obtained crystalline quenched foils are coarsely crushed, and are subjected to spark plasma sintering (SPS) under the following conditions to prepare a sintered body.

TABLE 2
SPS conditions

| Vacuum atmosphere | 10⁻² | Pa |
|---|---|---|
| Pressure | 300 | MPa |
| Temperature rising rate | 120° | C./min |

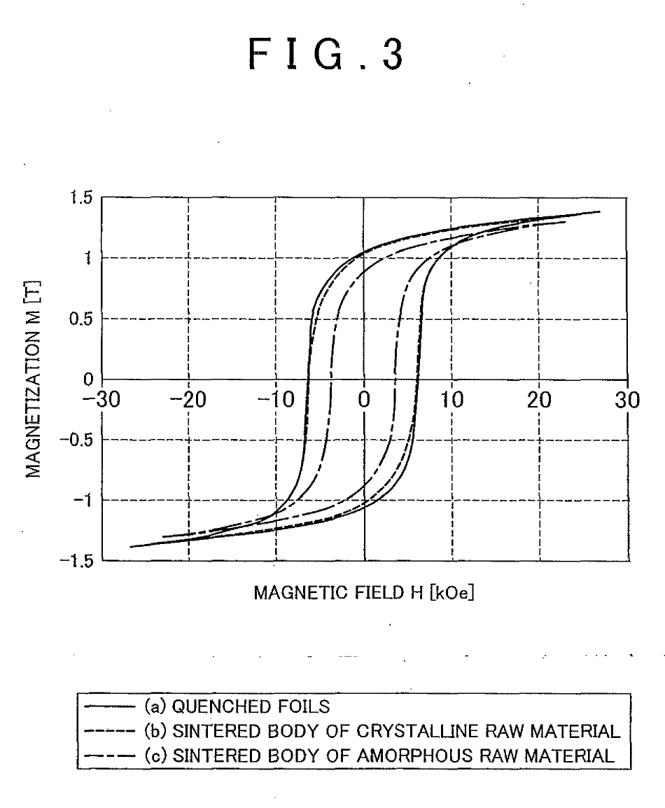

The magnetic characteristics of a sintered bulk body of the nanocomposite magnet fabricated as described above were measured using a Vibrating Sample Magnetometer (VSM). The magnetic characteristics of quenched foils before sintering, which serve as a reference, and of the sintered bulk body of a nanocomposite magnet according to a comparative example, which is formed by coarsely crushing only the amorphous quenched foils which are obtained as described above and performing SPS on the crushed amorphous quenched foils under the same conditions as described above were also measured in the same way. The results are shown altogether in FIG. 3.

As shown in FIG. 3, the sintered body (b) according to the present invention which was fabricated using only the crystalline quenched foils exhibited a magnetic hysteresis loop that was substantially the same as that exhibited by the quenched foils (a) before sintering. In addition, the magnetization (residual magnetization and saturation magnetization) and the coercive force of the sintered body (b) remained as high as those of the quenched foils before sintering (a).

In contrast, the sintered body (c) according to Comparative Example which was fabricated using only the amorphous quenched foils exhibited less magnetic hysteresis loop than that exhibited by the quenched foils (a) before sintering as well as the sintered body (b) formed by sintering the quenched foils (a). It is also seen that the magnetization and the coercive force of the sintered body (c) were reduced.

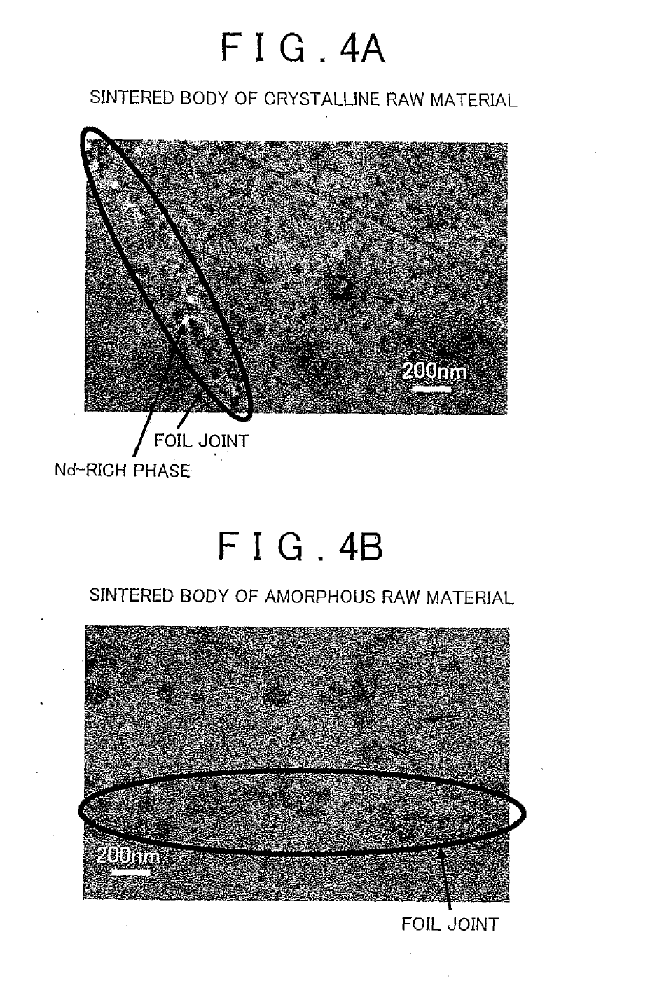

The structure was examined to investigate the cause of the difference in magnetic characteristics. FIGS. 4A and 4B each show a reflection electron image. FIG. 4A shows the nanocomposite magnet according to the present invention which was sintered using only the crystalline quenched foils. FIG. 4B shows the nanocomposite magnet according to Comparative Example which was sintered using only the amorphous quenched foils. Each image includes a joint formed by sintering the quenched foils. High contrast (white) areas correspond to the low melting point phase, which is rich in Nd. Low contrast (black) areas correspond to the soft magnetic phase, which is rich in αFe or Fe. Middle tone (gray) areas that are provided as the overall background correspond to the main phase (hard magnetic phase), which is made of Nd₂Fe₁₄B.

In the sintered body (b), which is fabricated using only the crystalline foils, as shown in FIG. 4A, the αFe- or Fe-rich soft magnetic phase, which is fine and about 20 nm sized, is uniformly dispersed. Meanwhile, in the sintered body (c), which is fabricated using only the amorphous foils, as shown in FIG. 4B, the soft magnetic phase, which is coarse, is non-uniformly dispersed. Thus, it is considered that the magnetic characteristics are significantly affected by whether the soft magnetic phase is finely dispersed.

A high contrast Nd-rich phase is clearly recognizable in the sintered body (b) according to the present invention, which is sintered using only the crystalline quenched foils. In contrast, no such Nd-rich phase is recognizable in the sintered body (c) according to Comparative Example, which is sintered using only the amorphous quenched foils.

When quenched foils were solidified via the single roll method as shown in FIG. 1, the cooling rate was varied, which resulted in a mixture of amorphous quenched foils that were solidified at a relatively high cooling rate and crystalline quenched foils that were solidified at a relatively low cooling rate. Therefore, the two types of quenched foils were separated as shown in FIG. 2.

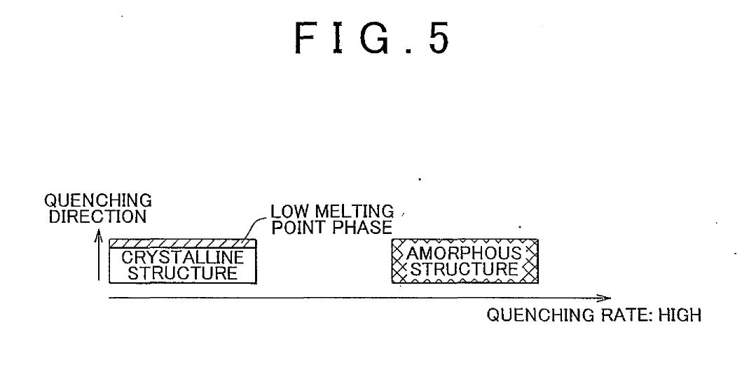

As schematically shown in FIG. 5, at a relatively low quenching rate at which crystalline quenched foils are formed, a low melting point phase is formed in a finally solidified portion. However, at a relatively high quenching rate at which amorphous quenched foils are formed, foils that are entirely amorphous are formed, and no low melting point phase appears.

Thus, it is necessary to sinter at a low temperature in order to avoid coarsening the fine structure of a raw material. The presence of a low melting point phase on a surface of a crystalline quenched foil facilitates sintering at low temperatures.

1. A method of producing a nanocomposite magnet, comprising:
quenching and solidifying a molten alloy that has a nanocomposite magnet composition to fabricate a foil that has a polycrystalline phase composed of a hard magnetic phase with an average crystal grain diameter of 10 to 200 nm and a soft magnetic phase with an average crystal grain diameter of 1 to 100 nm; and
sintering the foil that includes a low melting point phase that is formed on a surface of the foil and that has a melting point that is lower than that of the polycrystalline phase to obtain the nanocomposite magnet.

2. The method according to claim 1, wherein:
the quenching and solidifying is performed by a single roll method, and
the low melting point phase is formed on a surface of the foil that faces away from a roll used by the single roll method.

3. The method according to claim 2, further comprising:
separating the foil between a crystalline quenched foil from an amorphous quenched foil using a weak magnet, wherein only the crystalline quenched foil is sintered.

4. The method according to claim 1, wherein the sintering is performed by spark plasma sintering.

5. The method according to claim 1, wherein the sintering is performed at a temperature of 500 to 650° C.

6. The method according to claim 1, wherein the sintering is performed at a pressure of at least 200 MPa.

7. The method according to claim 1, wherein during the sintering of the foil the temperature is increased at a rate of at least 20° C./min.

8. The method according to claim 1, wherein the nanocomposite magnet composition is represented by a formula RₓQ_{y}M_{z}T_{1-x-y-z}, where:
R is at least one of rare-earth elements;
Q is at least one of B and C;
M is at least one element selected from the group consisting of Ti, Al, Si, V, Mn, Cu, Zn, Ga, Zr, Nb, Mo, Ag, Hf, Ta, W, Pt, Au, and Pb;
T is Fe or alloy of Fe that includes at least one of Co and Ni;
2≦x≦11.8;
1≦y≦24; and
0≦z≦10.
